(19) United States
(12) Patent Application Publication
(10) Pub. No.: US 2008/0264362 A1
(43) Pub. Date: Oct. 30, 2008

(54) ELECTROMAGNETICALLY DRIVEN VALVE

(75) Inventor: Yutaka SUGIE, Toyota-shi (JP)

Correspondence Address: SUGHRUE MION, PLLC, 2100 PENNSYLVANIA AVENUE, N.W., SUITE 800, WASHINGTON, DC, 20037, US

(73) Assignee: TOYOTA JIDOSHA KABUSHIKI KAISHA, Toyota-shi (JP)

(21) Appl. No.: 12/109,445

(22) Filed: Apr. 25, 2008

(30) Foreign Application Priority Data
Apr. 27, 2007 (JP) 2007-119316

(51) Int. Cl. F01L 9/04; F16K 31/06

(52) U.S. Cl. 123/90.11; 251/129.09

(57) ABSTRACT

An electromagnetically driven valve operated by electromagnetic force includes a stem, a driven valve, a swing member, and a first and second electromagnet. The first electromagnet and the second electromagnet include: a first and second core made of magnetic material, respectively; and a first and second coil, respectively, which are wound around the first core and the second core, respectively. The first coil and the second coil have the same number of turns, and are connected with each other. A magnetic path width of the second core is larger than a magnetic path width of the first core. When the swing member is located at a neutral position at which the swing member is in contact with neither the first electromagnet nor the second electromagnet, the distance between the second core and the swing member is smaller than the distance between the first core and the swing member.

### INCORPORATION BY REFERENCE

The disclosure of Japanese Patent Application No. JP2007-119316 filed on Apr. 27, 2007 including the specification, drawings and abstract is incorporated herein by reference in its entirety.

### BACKGROUND OF THE INVENTION

1. Field of the Invention

The invention relates to all electromagnetically driven valve, and more specifically, relates to an electromagnetically driven valve installed in a vehicle.

2. Description of the Related Art

An electromagnetically driven valve is described in, for example, Japanese Patent Application Publication No. 2007-32436 (No. JP-A-2007-32436), Japanese Patent Application Publication No. 2006-135025 (No. JP-A-2006-135025), German Patent Application Publication No. 10025491, and specifications of U.S. Pat. No. 7,088,209, U.S. Pat. No. 6,571,823, U.S. Pat. No. 6,467,441, and U.S. Pat. No. 6,481,396.

In an electromagnetically driven valve that includes a monocoil, an upper portion and a lower portion of the coil are simultaneously energized, and electromagnetic force is produced in both of the upper and the lower portions of the coil. This makes it difficult to produce starting electromagnetic force allowing the valve to move against a force of a spring, particularly when the electromagnetically driven valve (electromagnetic actuator) is started.

Further, if a difference in the number of turns is made between the upper portion and the lower portion of the coil in order to make a difference in the electromagnetic force between the upper portion and the lower portion of the coil, the response of the electromagnetic field is impaired in one of the upper and the lower portions that has the larger number of turns, and as a result, it becomes difficult to achieve the desired operation of the electromagnetically driven valve.

### SUMMARY OF THE INVENTION

The invention provides an electromagnetically driven valve in which startability of the electromagnetically driven valve (electromagnetic actuator) is improved without impairing the response of the electromagnetic field.

An aspect of the invention relates to an electromagnetically driven valve operated by electromagnetic force. The electromagnetically driven valve includes: a driven valve including a stem that reciprocates in an axial direction of the stem; a swing member extending from a first end portion, which moves together with one end of the stem, to a second end portion, wherein the swing member swings about a central axis extending on the second end portion side; and a first electromagnet and a second electromagnet that are disposed to face each other across the swing member. The first electromagnet and the second electromagnet include: a first core and a second core that are made of magnetic material, respectively; and a first coil and a second coil, respectively, which are wound around the first core and the second core, respectively. The number of turns of the first coil is equal to the number of turns of the second coil. The first coil and the second coil are connected with each other. A magnetic path width of the second core is larger than a magnetic path width of the first core. When the swing member is located at a neutral position at which the swing member is in contact with neither the first electromagnet nor the second electromagnet. The distance between the second core and the swing member is smaller than the distance between the first core and the swing member.

In the electromagnetically driven valve thus configured, because the number of turns of the first coil is equal to the number of turns of the second coil, it is possible to prevent the response of the electrical field from being impaired. Further, when the swing member is located at the neutral position at which the swing member is in contact with neither the first electromagnet nor the second electromagnet, the distance between the second core and the swing member is smaller than the distance between the first core and the swing member, and therefore, it is possible to cause the second core to reliably attract the swing member when the electromagnetically driven valve (electromagnetic actuator) is started, thereby improving the startability of the electromagnetically driven valve (electromagnetic actuator).

### BRIEF DESCRIPTION OF THE DRAWINGS

The foregoing and further objects, features and advantages of the invention will become apparent from the following description of preferred embodiments with reference to the accompanying drawings, wherein like numerals are used to represent like elements and wherein:

FIG. 1 schematically shows an electromagnetically driven valve according to a first embodiment of the invention;

FIG. 2 schematically shows the electromagnetically driven valve when a disk is located at a neutral position at which the disk is in contact with neither the upper electromagnet nor the lower electromagnet;

FIG. 3 schematically shows an electromagnetically driven valve according to a second embodiment of the invention;

FIG. 4 is a sectional view showing a second core according to the first embodiment in which a cutout is not provided;

FIG. 5 is a sectional view showing an electromagnetically driven valve according to a third embodiment of the invention when the electromagnetically driven valve is opened;

FIG. 6 is a sectional view showing the electromagnetically driven valve when the electromagnetically driven valve is closed;

FIG. 7 is a sectional view showing an electromagnetically driven valve according to a fourth embodiment of the invention; and

FIG. 8 is a side view showing an electromagnetically driven valve according to a fifth embodiment of the invention when viewed in a direction indicated by the arrow VIII shown in FIG. 7.

### DETAILED DESCRIPTION OF THE PREFERRED EMBODIMENTS

Hereinafter, embodiments of the invention will be described with reference to the attached drawings. The same or equivalent components in the embodiments below will be denoted by the same reference numerals, and the description thereof will not be repeated. It is possible to combine the embodiments described below.

### First Embodiment

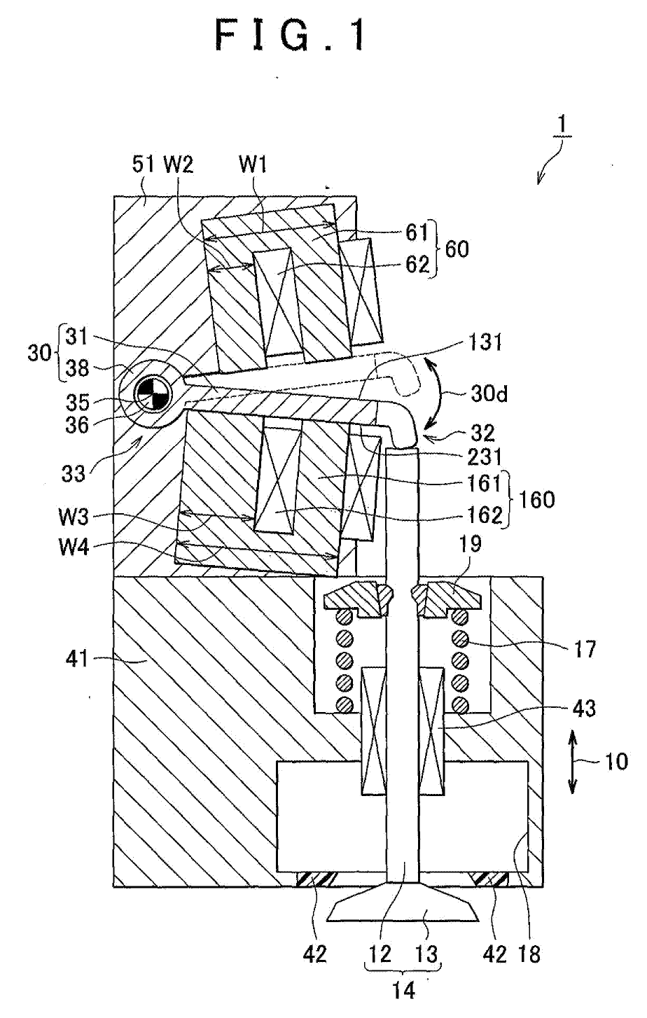

FIG. 1 schematically shows an electromagnetically driven valve according to a first embodiment of the invention. In FIG. 1, the solid line shows the state where the electromagnetically driven valve is opened, and the dotted line shows the state where the electromagnetically driven valve is closed. An electromagnetically driven valve 1 includes a main body 51, an upper electromagnet 60 and a lower electromagnet 160 that are installed in the main body 51, and a disk 30 interposed between the upper electromagnet 60 and the lower electromagnet 160.

The electromagnetically driven valve 1 includes: a stem 12 that functions as a valve shaft; a driven valve 14 that reciprocates in a direction in which the stem 12 extends (that is, in a direction as indicated by an arrow 10 in the drawing); the main body 51 that is disposed away from the driven valve 14 and functions as a support member; a first end portion 32 that moves together with the stem 12; a second end portion 33 that is swingably supported by the main body 51; and the disk 30 that functions as a swing member and swings about a central axis 35 extending at the second end portion 33.

The disk 30 is provided between the upper electromagnet 60 and the lower electromagnet 160, and is alternately attracted to the upper electromagnet 60 and the lower electromagnet 160 by magnetic force. This causes the disk 30 to oscillate between the upper electromagnet 60 and the lower electromagnet 160. The oscillation motion of the disk 30 is transmitted to the stem 12.

The electromagnetically driven valve 1 according to the first embodiment is employed as an intake valve or an exhaust valve for an internal combustion engine, such as a gasoline engine and a diesel engine. In the first embodiment, the electromagnetically driven valve 1 is described as an intake valve provided for an intake port 18. However, the invention may be applied to a driven valve functioning as an exhaust valve or other type of driven valve.

The main body 51 is provided on a cylinder head 41. The lower electromagnet 160 is provided in a lower side of the main body 51, and the upper electromagnet 60 is provided in an upper side of the main body 51. The lower electromagnet 160 includes a second core 161 that is made of iron, and a second coil 162 that is wound around the second core 161. When the second coil 162 is energized, a magnetic field is produced in a region surrounded by the second coil 162, and the magnetic force due to the magnetic field attracts the disk 30. On the other hand, the upper electromagnet 60 includes a first core 61 that is made of iron, and a first coil 62 that is wound around the first core 61. When the first coil 62 is energized, a magnetic field is produced in a region surrounded by the first coil 62, and the magnetic force due to the magnetic field attracts the disk 30.

The first coil 62 of the upper electromagnet 60 is connected with the second coil 162 of the lower electromagnet 160, thereby forming a monocoil. The number of turns of the first coil 62 is equal to the number of turns of the second coil 162.

The disk 30 includes an arm portion 31 and a bearing portion 38. The arm portion 31 extends from the first end portion 32 to the second end portion 33. The arm portion 31 swings (pivots) in directions indicated by an arrow 30d, attracted by the upper electromagnet 60 and the lower electromagnet 160. The bearing portion 38 is provided at an end of the arm portion 31 on the second end portion 33 side, and the arm portion 31 pivots about the bearing portion 38. An upper surface 131 of the arm portion 31 is brought into contact with the upper electromagnet 60, and a lower surface 231 of the arm portion 31 is brought into contact with the lower electromagnet 160. Further, the first end portion 32 of the disk 30 is placed in contact with the stem 12. The stem 12 is guided by a stem guide 43.

The bearing portion 38 has a cylindrical shape and houses a torsion bar 36 therein. A first end of the torsion bar 36 is spline-fitted to the main body 51, and a second end of the torsion bar 36 is fitted into the bearing portion 38. With this configuration, when the bearing portion 38 is urged to rotate, a force that acts against the rotational motion of the bearing portion 38 is transmitted from the torsion bar 36 to the bearing portion 38. Therefore, when no external force (magnetic force) is applied, the bearing portion 38 is located at a neutral position at which the disk 30 is in contact with neither the upper electromagnet 60 nor the lower electromagnet 160. It should be noted that, the “neutral position” means a position at which the disk 30 is in contact with neither the upper electromagnet 60 nor the lower electromagnet 160, and may be a predetermined position.

The intake port 18 is provided in a lower portion of the cylinder head 41, and functions as a passage through which intake air is introduced into a combustion chamber. The air or mixture gas passes through the intake port 18. A valve seat 42 is provided between the intake port 18 and the combustion chamber, and improves the air tightness of the driven valve 14.

The driven valve 14 is attached to the cylinder head 41 as an intake valve. The driven valve 14 includes the stem 12 that extends in a direction in which the driven valve 14 reciprocates, and an umbrella portion 13 is attached to one end of the stem 12. Further, an upper end portion of the stem 12 is fitted with a spring retainer 19, and the stem 12 and the spring retainer 19 move together. The spring retainer 19 is urged upward by a valve spring 17.

When compared, an entire width W4 of the second core 161 provided in the lower side of the main body 51 is larger than an entire width W1 of the first core 61 provided in the upper side of the main body 51, and a magnetic path width W3 of the second core 161 (which is the width of the portion of the second coil 162 on the left side as shown in the drawings) is larger than a magnetic path width W2 of the first core 61 (which is the width of the portion of the first coil 62 on the left side as shown in the drawings).

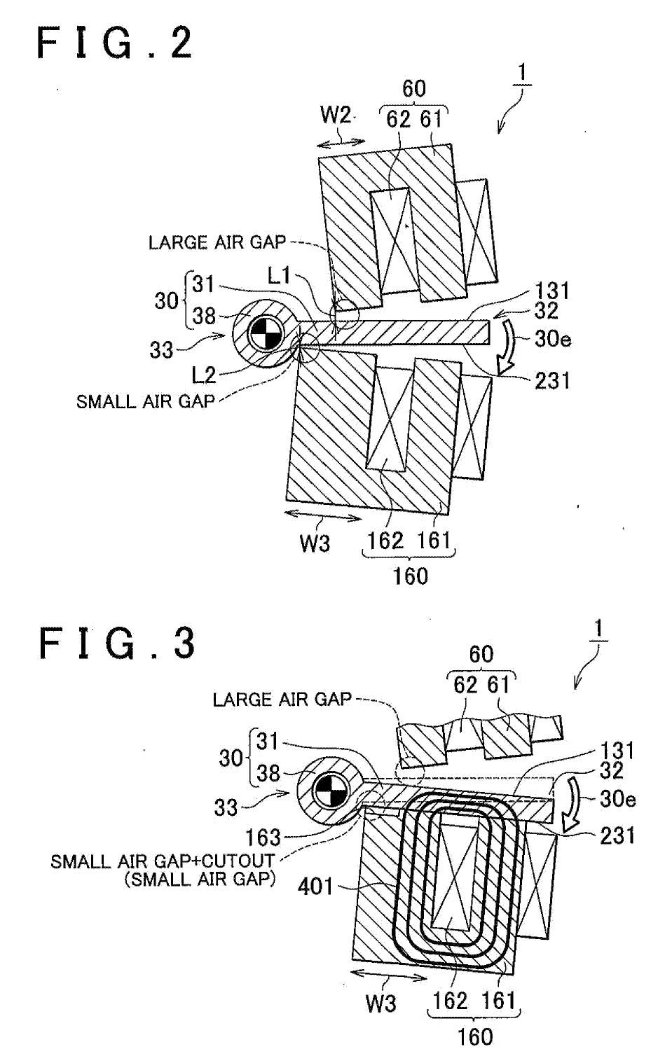

FIG. 2 schematically shows the state of the electromagnetically driven valve 1 where the disk 30 is located at the neutral position at which the disk 30 is in contact with neither the upper electromagnet 60 nor the lower electromagnet 160. In this case, an air gap L2 between the disk 30 and the second core 161 is smaller than an air gap L1 between the disk 30 and the first core 61. According to this configuration, the magnetic path width W3 of the second core 161, which attracts the disk 30 when the electromagnetically driven valve 1 (electromagnetic actuator) is started, is larger than the magnetic path width W2 of the first core 61 disposed opposite to the second core 161, so that it is possible to make the air gap L2 between the disk 30 and the second core 161 small before the electromagnetically driven valve 1 (electromagnetic actuator) is started. In addition) because the air gap L2 is smaller than the air gap L1, it is possible to make a difference between the electromagnetic force of the upper electromagnet 60, which functions as a first electromagnet, and the electromagnetic force of the lower electromagnet 160, which functions as a second electromagnet, even in the case of adopting a monocoil configuration. Thus, it is possible to ensure that the electromagnetically driven valve 1 (electromagnetic actuator) is started.

The basic formulae for a magnetic circuit pertaining to the invention are as follows:

$$\begin{matrix}Electromagnetic force \text{:} F = \frac{{B}^{2} S}{{μ}_{0}} \\ Magnetic flux density \text{:} B = \frac{φ}{S}\end{matrix} ] F = \frac{{φ}^{2}}{{μ}_{0} S} \\ Magnetic flux \text{:} φ = \frac{I N}{{R}_{m}} \\ Rate of change with time of magnetic flux \text{:} \frac{d φ}{d t} = \frac{V - IR}{N} \\ ( \approx response of electromagnetic field ) ( \begin{matrix} S \text{:} Magnetic path cross section \\ {μ}_{0} \text{:} Magnetic permeability of air \\ N , R \text{:} Number of turns , resistance of a coil \\ {R}_{m} \text{:} Magnetic resistance \\ I , V \text{:} current , voltage\end{matrix} ) \qquad [ Equation 1 ]$$

In a method of increasing the electromagnetic force, a magnetic flux Φ and a magnetic flux density B are increased by increasing the number of coil turns N. However, if this method is used, the rate of change with time of the magnetic flux (dΦ/dt), which indicates the response of electromagnetic field, becomes smaller, which results in impairment of response. In order to solve this, a magnetic path cross section S, which is one of the factors determining the build of a core, is reduced instead of changing the number of coil turns N. This makes it possible to increase an electromagnetic force F while minimizing adverse effects on the response of the electromagnetic field.

It should be noted that the magnetic flux density B is a factor that has saturative characteristics, and therefore the magnetic path cross section S and the electromagnetic force F have the optimal solutions.

Accordingly, in the electromagnetically driven valve (electromagnetic actuator) including a monocoil, in order to increase the starting electromagnetic force without impairing the response of the electromagnetic field (that is, the operation), it is effective to equalize the number of turns of the upper coil and the number of turns of the lower coil, thereby ensuring good response, and in addition make a difference in builds of the upper and the lower cores.

In the first embodiment, the electromagnetically driven valve 1 is configured so that the electromagnetic force of the lower electromagnet 160 is larger than the electromagnetic force of the upper electromagnet 60. However, the electromagnetically driven valve 1 may be configured so that the electromagnetic force of the upper electromagnet 60 is larger than the electromagnetic force of the lower electromagnet 160.

### Second Embodiment

FIG. 3 schematically shows an electromagnetically driven valve according to a second embodiment of the invention. In FIG. 3, the solid line shows the state where the electromagnetically driven valve 1 is opened, and the dotted line shows the state where the disk 30 is located at the neutral position at which the disk 30 is in contact with neither the upper electromagnet 60 nor the lower electromagnet 160. The electromagnetically driven valve 1 according to the second embodiment differs from the electromagnetically driven valve according to the first embodiment in being provided with a stepped cutout 163 formed in a portion of the second core 161 on the second end portion 33 side. The same components of the second embodiment as those of the first embodiment will be denoted by the same reference numerals, and the description thereof will not be repeated. In the electromagnetically driven valve 1 according to the second embodiment, the disk 30 pivots in a direction indicated by an arrow 30e when the electromagnetically driven valve 1 (electromagnetic actuator) is started. When the electromagnetically driven valve 1 is held open, the disk 30 is in contact with the second core 161. It should be noted that the cutout 163 may be provided in a portion of the second core 161 other than a portion on the second end portion 33 side.

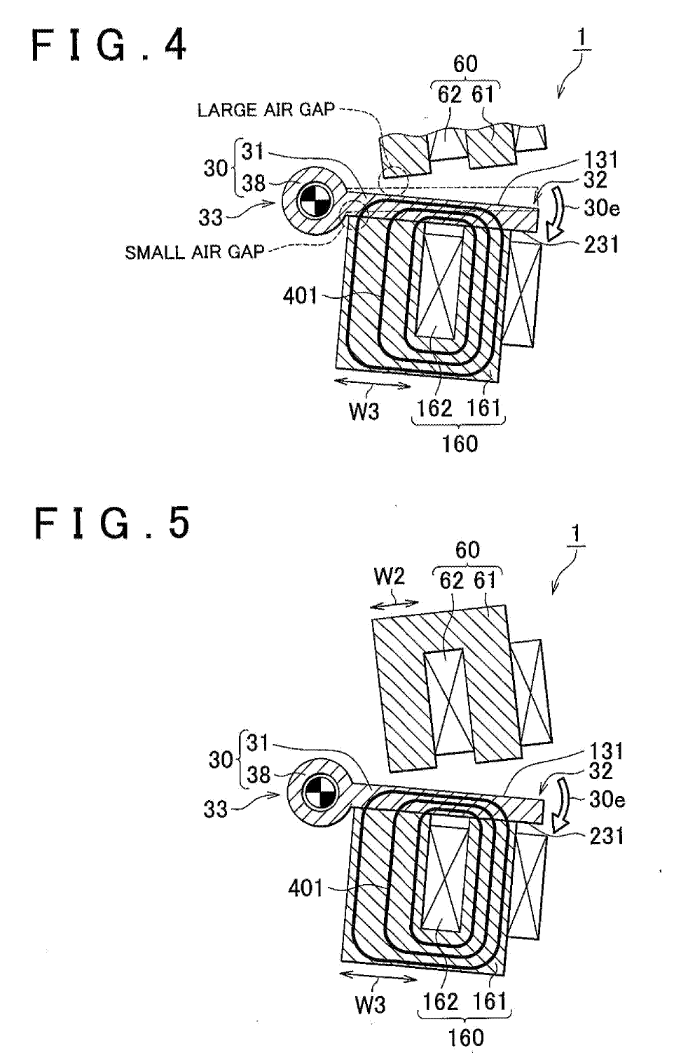

Corresponding to FIG. 3 of the second embodiment, FIG. 4 shows a sectional view of the second core 161 according to the first embodiment in which the cutout is not formed. In FIG. 4, the solid line shows the state where the electromagnetically driven valve is opened, and the dotted line shows the state where the disk 30 is located at the neutral position at which the disk 30 is in contact with neither the upper electromagnet 60 nor the lower electromagnet 160. As shown in FIG. 4, if the cutout is not formed in the second core 161, magnetic lines of force 401 are sparsely distributed, and therefore the magnetic flux density is small. Compared to FIG. 4, in the electromagnetically driven valve 1 of the second embodiment as shown in FIG. 3, the magnetic flux is concentrated in a portion, other than the cutout 163, where the disk 30 is in close contact with the second core 161, as shown by the magnetic lines of force 401. Therefore, it is possible to further increase the holding electromagnetic force to hold the disk 30, compared to the first embodiment. Consequently, it is possible to reduce the power consumed by the electromagnetically driven valve 1

### Third Embodiment

FIG. 5 is a sectional view showing an electromagnetically driven valve according to a third embodiment of the invention when the electromagnetically driven valve is opened. The same components of the third embodiment as those of the first and the second embodiments will be denoted by the same reference numerals) and the description thereof will not be repeated. In the electromagnetically driven valve 1 according to the third embodiment, when a difference is made between the magnetic path width of the upper electromagnet 60 and the magnetic path width of the lower electromagnet 160 in order to archive the desired initial driving performance, one of the first core 61 and the second core 161 that has the narrower magnetic path width, that is, that generates larger holding electromagnetic force, is disposed above the other core. In the valve system of an internal combustion engine, the time during which valves are closed is longer than the time during which valves are opened, and this particularly applies when the engine speed is low. Therefore, if an electromagnet core with the narrower magnetic path width is disposed above the other electromagnet core with the broader magnetic path width, it is possible to reduce the electric current that keeps the valve closed and power consumption of the entire system, which makes it possible to improve fuel economy. In other words, as shown in FIG. 5, the first core 61 that has a narrower magnetic path width W2 is disposed vertically above the second core 161. The core that has the narrower magnetic path width may be disposed on the lower side.

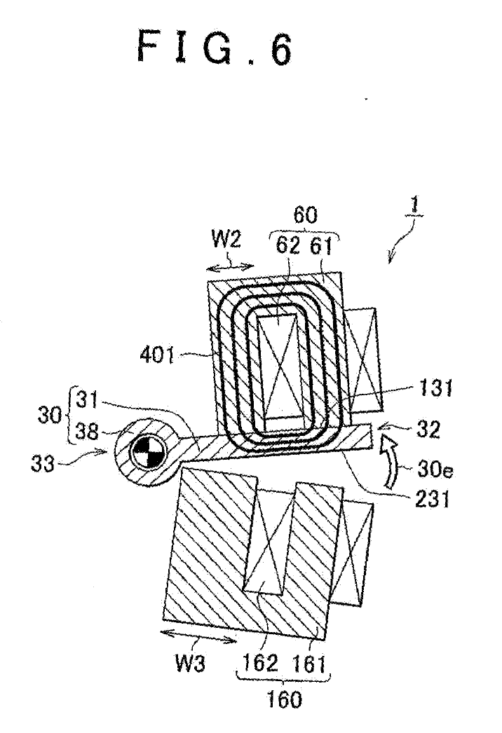

FIG. 6 is a sectional view showing the electromagnetically driven valve 1 according to the third embodiment when the electromagnetically driven valve 1 is closed. When the electromagnetically driven valve 1 is closed (the duration of such closure of the valve is long when the engine is in operation), the disk 30 is attracted to the upper electromagnet 60. During this, because the magnetic path width of the first core 61 of the upper electromagnet 60 is narrower than that of the second core 161 of the lower electromagnet 160, the first core 61 causes higher magnetic flux density and larger holding electromagnetic force.

### Fourth Embodiment

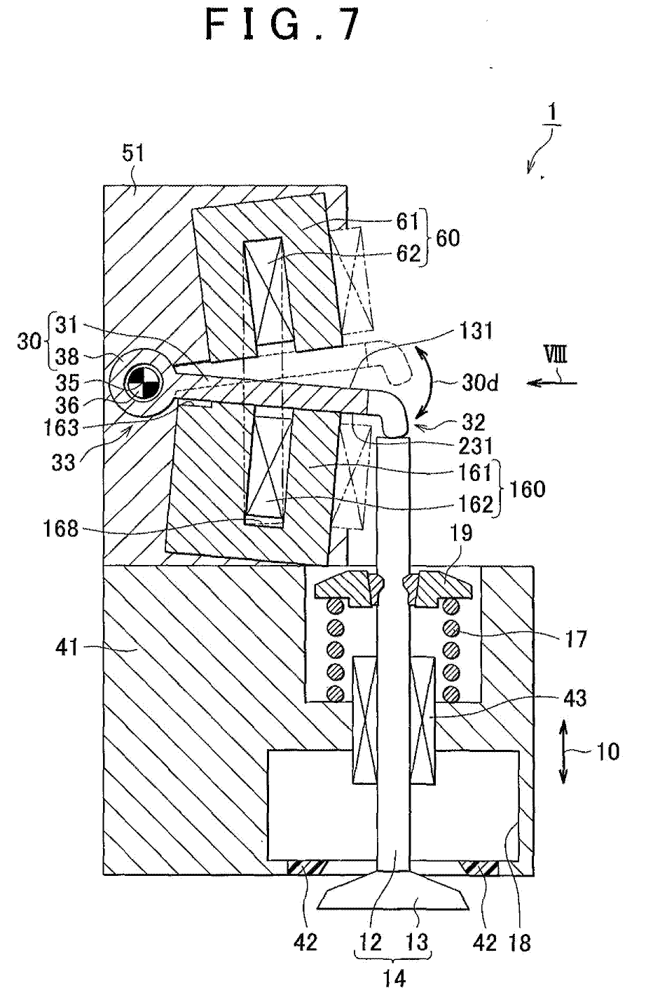

FIG. 7 is a sectional view of an electromagnetically driven valve according to a fourth embodiment of the invention. In FIG. 7, the solid line shows the state where the electromagnetically driven valve 1 is opened, and the dotted line shows the state where the disk 30 is located at the neutral position at which the disk 30 is in contact with neither the upper electromagnet 60 nor the lower electromagnet 160. Further, the same components of the fourth embodiment as those of the aforementioned embodiments will be denoted by the same reference numerals, and the description thereof will not be repeated. In the electromagnetically driven valve 1 according to the fourth embodiment, the first coil 62 on the U-shaped first core 61 is formed integrally with the second coil 162 on the second core 161 by a single coil. The rectangular shown by the dotted line indicates the connection portion between the first coil 62 and the second coil 162. No coil is provided at the positions indicated by the chain double-dashed line in FIG. 7. With regard to the electromagnetically driven valve 1 according to the fourth embodiment, production cost is reduced by reducing the number of components. In addition, power consumption is reduced by downsizing, the electromagnetically driven valve 1 (electromagnetic actuator) and reducing coil resistance.

### Fifth Embodiment

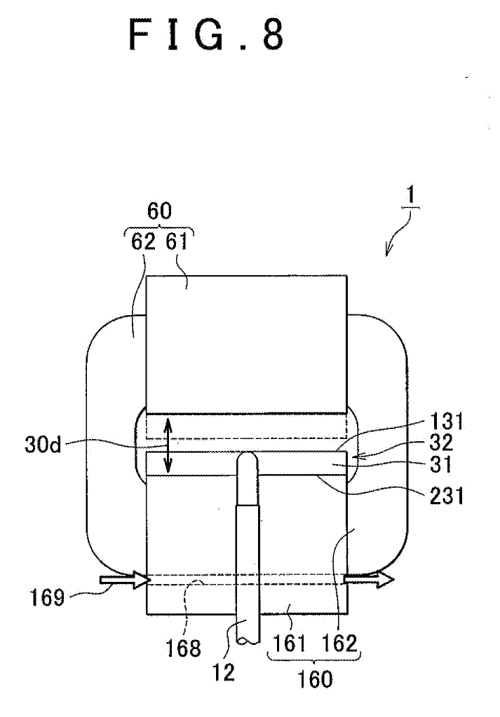

FIG. 8 is a side view of an electromagnetically driven valve according to a fifth embodiment of the invention when viewed in a direction indicated by an arrow VIII in FIG. 7. The same components of the fifth embodiment as those of the aforementioned embodiments will be denoted by the same reference numerals, and the description thereof will not be repeated. The electromagnetically driven valve 1 according to the fifth embodiment differs from the electromagnetically driven valve 1 according to the third embodiment in including a coolant passage 168 formed in the second core 161 disposed on the lower side. Coolant flows through the coolant passage 168 in a direction indicated by an arrow 169 shown in FIG. 8. The coolant may be cooling oil or cooling water. The coolant passage 168 is provided so as to be adjacent to the second coil 162, and only the lower portion of the lower electromagnet 160 is cooled to reduce heat generation. In the electromagnetically driven valve 1 according to the aforementioned embodiments including separate upper and lower coils, it is necessary to provide a separate coolant passage for each of the upper and the lower electromagnets in order to cool both of the upper electromagnet and the lower electromagnet. However, in the case of the integrated single coil of the fifth embodiment, it is no longer necessary to provide separate coolant passages. This configuration makes it possible to prevent increase of the coil resistance, and further, to minimize power consumption. In addition, it is possible to improve durability of the coil.

While the invention has been described with reference to example embodiments thereof, it is to be understood that the invention is not limited to the example embodiments or constructions. To the contrary, the invention is intended to cover various modifications and equivalent arrangements. In addition, while the various elements of the example embodiments are shown in various combinations and configurations, which are example, other combinations and configurations, including more, less or only a single element, are also within the spirit and scope of the invention.

What is claimed is:

1. An electromagnetically driven valve operated by electromagnetic force, comprising:
a driven valve including a stem that reciprocates in an axial direction of the stem;
a swing member extending from a first end portion, which moves together with one end of the stem, to a second end portion, wherein the swing member swings about a central axis extending on the second end portion side; and
a first electromagnet and a second electromagnet that are disposed to face each other across the swing member, wherein
the first electromagnet and the second electromagnet include: a first core and a second core that are made of magnetic material, respectively; and a first coil and a second coil, respectively, which are wound around the first core and the second core, respectively,
a number of turns of the first coil is equal to a number of turns of the second coil,
the first coil and the second coil are connected with each other,
a magnetic path width of the second core is larger than a magnetic path width of the first core, and
when the swing member is located at a neutral position at which the swing member is in contact with neither the first electromagnet nor the second electromagnet, a distance between the second core and the swing member is smaller than a distance between the first core and the swing member.

2. The electromagnetically driven valve according to claim 1, wherein a magnetic path width of the second core on the second end portion side is larger than a magnetic path width of the first core on the second end portion side.

3. The electromagnetically driven valve according to claim 2, wherein a cutout is provided in the second core on the second end portion side.

4. The electromagnetically driven valve according to claim 1, wherein the first core is disposed vertically above the second core.

5. The electromagnetically driven valve according to claim 1, wherein the first core is located, relative to the second core, in a direction parallel to a longitudinal direction of the stem from the other end to the one end of the stem.

6. The electromagnetically driven valve according to claim 1, further comprising a position-maintaining portion that maintains the swing member at the neutral position at which the swing portion is in contact with neither the first electromagnet nor the second electromagnet, wherein the position-maintaining portion is a bearing provided with a torsion bar.

7. The electromagnetically driven valve according to claim 1, further comprising an urging member that urges the stem in the longitudinal direction of the stem from the other end to the one end of the stem.

8. The electromagnetically driven valve according to claim 1, wherein the first coil and the second coil are integrally formed by a single common coil.

9. The electromagnetically driven valve according to claim 8, wherein a coolant passage is provided in the second core.
